(19) United States
(12) Patent Application Publication
(10) Pub. No.: US 2012/0326664 A1
(43) Pub. Date: Dec. 27, 2012

(54) CHARGING STAND FOR ELECTRIC AND HYBRID VEHICLES

(76) Inventor: Frank Venegas, JR., Bingham Farms, MI (US)

(21) Appl. No.: 13/460,346

(22) Filed: Apr. 30, 2012

Related U.S. Application Data
(60) Provisional application No. 61/480,810, filed on Apr. 29, 2011.

(51) Int. Cl. H02J 7/00

(52) U.S. Cl. 320/109

(57) ABSTRACT

A charging stand for an electric or hybrid vehicle includes a retractable cable. The retractable cable may further include a light and, in the preferred embodiments, the plug may include a button to automatically retract the cord utilizing a motor within the stand.

### REFERENCE TO RELATED APPLICATION

This application claims priority from U.S. Provisional Patent Application Ser. No. 61/480,810, filed Apr. 29, 2011, the entire content of which is incorporated herein by reference.

### FIELD OF THE INVENTION

This invention relates generally to electric and hybrid vehicles and, in particular, to a charging stand for such vehicles including a polymeric plastic sheath that may be fitted over a bollard or pole.

### BACKGROUND OF THE INVENTION

With the advent of electric and hybrid vehicles such as the Chevy Volt, Nissan Leaf, and others, the need has arisen for charging stands not only at homes and businesses, but at public places such as parking structures, hotels and so forth. As with gas pumps, such a charging stand will require an electric cord that runs from the stand to the vehicle. Existing stands are not designed very well, however, in that at times they will need to be operated during inclement weather, including snow and rain. It is undesirable for individuals to handle the cords particularly in such cases, as they will become dirty or muddy. Furthermore, existing charging stand designs do not take into account that the cables will include metals which might become valuable, thereby leading to vandalism or theft.

### SUMMARY OF THE INVENTION

This invention resides in a charging stand for an electric or hybrid vehicle including a retractable cable. The retractable cable may further include a light and, in the preferred embodiments, the plug may include a button to automatically retract the cord utilizing a motor within the stand.

### BRIEF DESCRIPTION OF THE DRAWINGS

FIG. 1 shows a basic embodiment according to the invention;

FIG. 2 shows how the inventive charging stand may be equipped with a light;

FIG. 3 shows a different embodiment of the invention including provisions to guard against vandalism and theft;

FIG. 4 shows how the axis of rotation may be generally vertical;

FIG. 5 shows how the retractable cable and housing with door may be disposed under the control panel; and

FIG. 6 shows an alternative embodiment of the invention which is mounted against a wall or other surface.

### DETAILED DESCRIPTION OF THE INVENTION

This invention solves the above problems by providing a charging stand for electric and hybrid vehicles which includes features to improve use and/or safety.

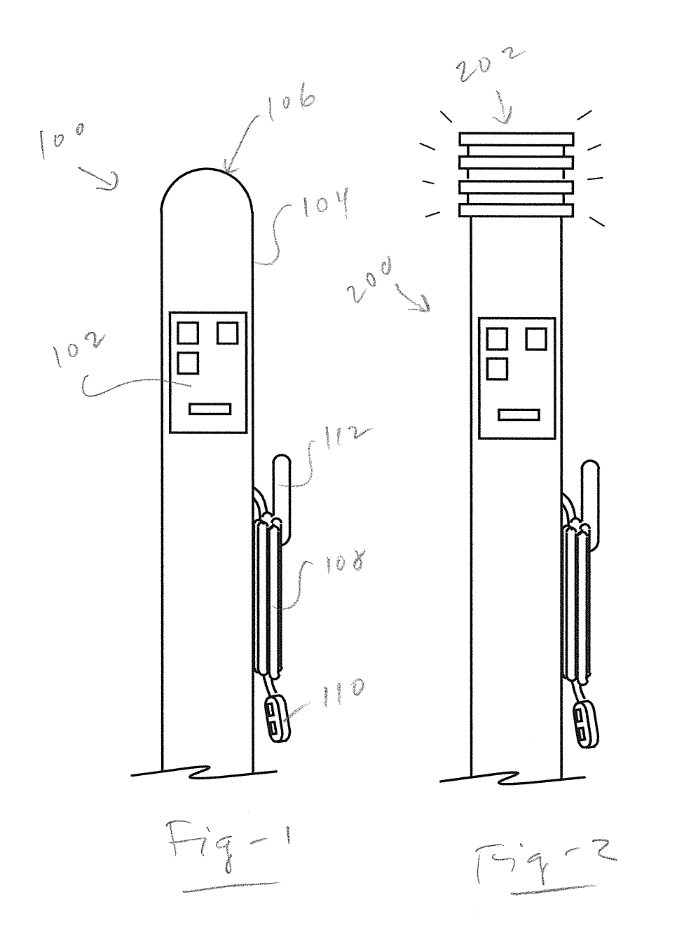

FIG. 1 shows a basic embodiment according to the invention depicted generally at 100. This embodiment includes the telemetric sheath 104 into or onto which there is mounted an electric charging control unit 102 which may be obtained from commercial manufacturers. The polymeric sheath 104 may have a hemispherical top 106, and may be constructed from polyethylene or other suitable materials. The sheath may be fabricated with known processes such as rotational molding, blow molding, extrusion and so forth, and may include different colorants, UV inhibitors and so forth.

The sheath 104 may be dimensioned to fit over a post, pole or bollard (not shown), in which case it may be advantageous to mount the control unit 102 outside of the inner diameter of the bollard to accommodate taller posts. The electric cord used for recharging 108 in this case is shown hanging on the side of the assembly from a hook 112 extending from the side wall of the sheath 104. The cable 108 terminates in a plug 110 configured for attachment to the electric/hybrid vehicle for recharging purposes.

In all embodiments, the inventive charging stand may be equipped with a light 202 and shown in FIG. 2. This light may preferably be powered from the same electricity used for vehicle recharging purposes, and may include a photo cell or other light detector such that the light only comes on during darker periods of time. Alternatively, a sensor may be provided, such that the light only comes on when an individual or vehicle comes in close proximity to the charging stand 200.

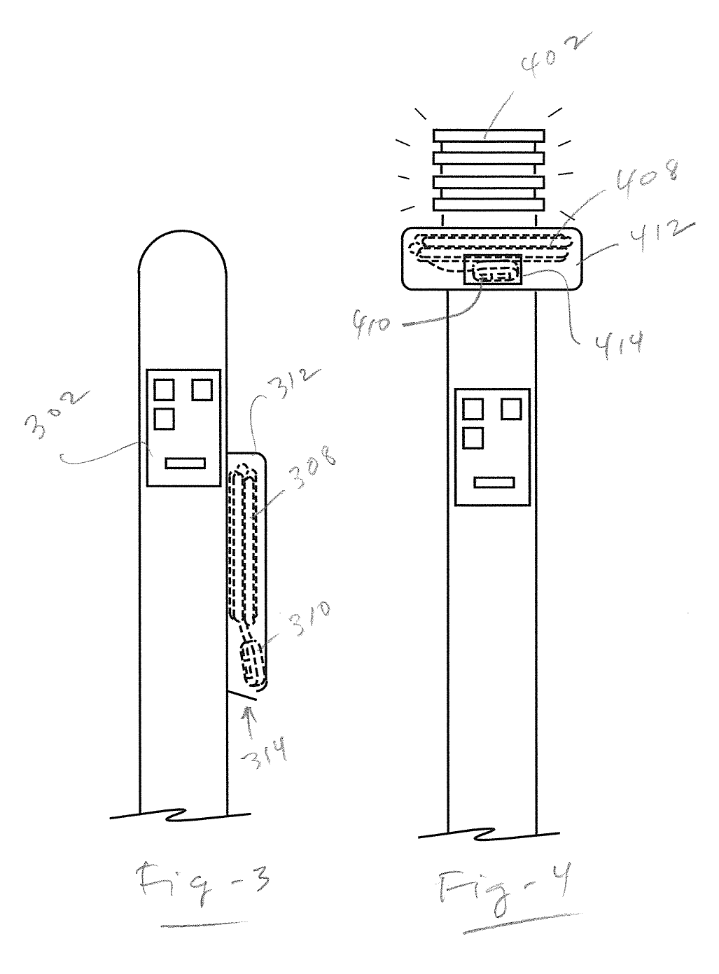

FIG. 3 shows a different embodiment of the invention including provisions to guard against vandalism and theft. In this case, the recharging cable 308 is disposed on a retractable wheel within a housing 312. A door 314 may be provided to gain access to the plug 310, and in this and other embodiments disclosed herein, such a door may not open until the controls 302 have confirmed that an authorized user is accessing the stand. When the door 314 is opened, the user may grab the plug 310 and pull the retractable cable 308 off the reel (not shown). To retract the cable, the user might exert a slight forward extension of the cable, enabling a ratchet mechanism and return spring to wind the cable 308 back onto the reel. As a further alternative, the reel may be motorized, in which case one of the buttons on the plug 310 may be used for retraction purposes. In other words, when an individual has been recharging their vehicle, they may simple press one of the buttons on the plug 310 when it is unplugged from the vehicle, activating a motor which will slowly wind the cable 308 back onto the reel, with the user perhaps guiding it back into the door 314.

While the axis of rotation of retractable of the retractable reel 308 in FIG. 3 is generally horizontal, the axis of rotation may be generally vertical, as shown in FIG. 4. In this configuration, the reel 408 is disposed in a horizontally oriented housing 412, again with a door 414 which may be provided to gain access to the plug 410. As stated earlier, a light 402 may be included in this and other embodiments.

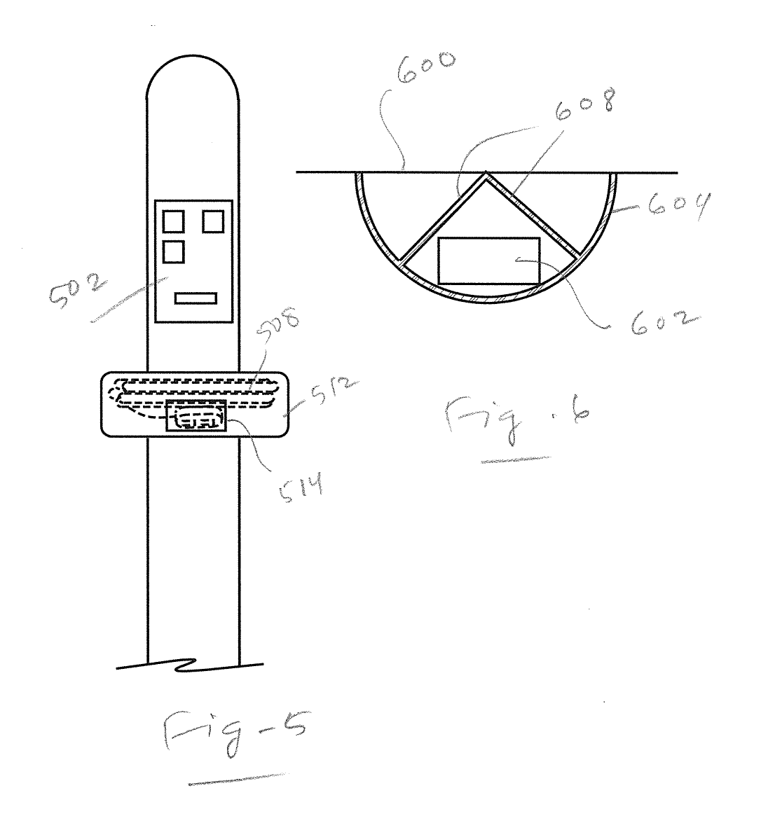

FIG. 5 shows how a retractable cable 508 and housing 512 with door 514 may be disposed under the control panel 502 as opposed to above it as shown in FIG. 4.

As opposed to a free-standing sheath or bollard cover as depicted in FIGS. 1 through 5, FIG. 6 shows an alternative embodiment of the invention which is mounted against a wall or other surface 600. In this case, as seen from above in partial cross-section, the control 602 is mounted on or within a structure 604 which may include a hemispherical outer surface and inner ribs 608 providing crush resistance in the event that a vehicle happens to bump into the assembly.

1. A charging stand for an electric or hybrid vehicle including a retractable cable.

2. A charging stand for an electric or hybrid vehicle including a retractable cable and a light.

3. A charging stand for an electric or hybrid vehicle including a retractable cable terminating in a plug adapted for vehicle attachment; and
wherein the plug includes a button to automatically retract the cord utilizing a motor within the stand.
